(19) United States
(12) Patent Application Publication
(10) Pub. No.: US 2025/0197693 A1
(43) Pub. Date: Jun. 19, 2025

(54) CONDUCTIVE ADHESIVE, ELECTROCHEMICAL APPARATUS, AND ELECTRONIC APPARATUS

(71) Applicant: Dongguan Amperex Technology Limited, Dongguan (CN)

(72) Inventor: Kewen HU, Dongguan (CN)

(73) Assignee: Dongguan Amperex Technology Limited, Dongguan (CN)

(21) Appl. No.: 18/748,721

(22) Filed: Jun. 20, 2024

Related U.S. Application Data
(63) Continuation of application No. PCT/CN2021/139726, filed on Dec. 20, 2021.

(51) Int. Cl. C09J 9/02; C09J 11/04; C09J 163/10; H01M 50/536

(52) U.S. Cl. CPC C09J 9/02; C09J 11/04; C09J 163/10; H01M 50/536

(57) ABSTRACT

A conductive adhesive includes a substrate and a conductive filler, where the substrate includes modified epoxy resin, polyurethane, and polyimide. The conductive adhesive can replace laser welding and is used in the electrochemical apparatus, so that production efficiency of the electrochemical apparatus can be improved, and quality of the electrochemical apparatus is also improved.

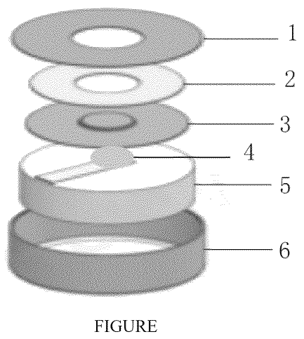

### CROSS REFERENCE TO THE RELATED APPLICATIONS

This application is a continuation under 35 U.S.C. § 120 of international patent application PCT/CN2021/139726 filed on Dec. 20, 2021, the entire content of which is incorporated herein by reference.

### TECHNICAL FIELD

This application relates to the field of energy storage, and in particular, to a conductive adhesive, an electrochemical apparatus, and an electronic apparatus.

### BACKGROUND

A lithium-ion battery is widely used in various electronic products such as a mobile terminal, an electronic tool, and an electric vehicle. In a button battery used in a wearable device such as Bluetooth headsets, laser welding is usually used to fasten a tab and a terminal. However, during laser welding, a welding defect is easy to occur, which affects production efficiency of the battery. In order to resolve this problem, the prior art attempts to use a conductive adhesive to replace laser welding.

However, the conductive adhesive in the prior art has the following problems: (1) a low shear strength, generally <5 MPa, of the conductive adhesive bond to a metal such as Al, Cu, or Ni; (2) a large swelling ratio and dissolution rate in an electrolyte solution system, resulting in accelerated capacity attenuation and thickness swelling during a battery cycle, and even causing black or purple spots; (3) poor conductivity and incapability of replacing conductive performance of laser welding; (4) some conductive particles being easily oxidized, for example, Al generating insulated Al₂O₃ and Al³⁺ causing an impurity ion content to exceed the standard; and (5) rheological parameters not meeting a dispensing process. Therefore, it is necessary to develop an improved conductive adhesive that can be used in an electrochemical apparatus to achieve conductive bonding and replace laser welding.

### SUMMARY

In view of the shortcomings in the prior art, this application provides a conductive adhesive, an electrochemical apparatus including the conductive adhesive, and an electronic apparatus. The conductive adhesive replaces laser welding and is used in the electrochemical apparatus, so that production efficiency of the electrochemical apparatus can be improved, and quality of the electrochemical apparatus is also improved.

According to a first aspect, this application provides a conductive adhesive, including a substrate and a conductive filler, where the substrate includes modified epoxy resin, polyurethane, and polyimide.

In this application, the substrate in the conductive adhesive can form a molecular skeleton of the conductive adhesive, provide mechanical performance and a bonding function, and enable conductive filler particles to form channels. The conductive filler particles contact each other, and a tunnel effect enables the particles to form the current channels. The substrate in this application includes three constituents: the modified epoxy resin, the polyurethane, and the polyimide. The modified epoxy resin can resolve shortcomings such as high brittleness and poor toughness of epoxy resin. The polyurethane improves impact damage resistance performance and has a good vibration absorption effect. The polyimide can withstand a high temperature up to 400° C. and can be used for long time at 200° C. to 300° C.

According to some implementations of this application, the modified epoxy resin includes carboxyl and/or cyano. The active functional group carboxyl can react with an epoxy group in the epoxy resin. The cyano (—CN group) has strong polarity, and can have good miscibility with the epoxy resin.

According to some implementations of this application, based on a mass of the conductive adhesive, a mass content of the substrate ranges from 50% to 85%. A higher mass proportion of the substrate indicates higher viscosity, a larger thixotropic index, and a larger shear strength of the conductive adhesive. Increased shear strength of the conductive adhesive can improve reliability of a bonding interface and further improve conductivity performance of the electrochemical apparatus. According to some implementations of this application, based on the mass of the conductive adhesive, the mass content of the substrate is 55%, 60%, 62%, 65%, 68%, 70%, 72%, 75%, 78%, 80%, 82%, 85%, or a value within a range of any two of the values.

According to some implementations of this application, based on the mass of the conductive adhesive, a mass content of the conductive filler ranges from 10% to 45%. A higher mass proportion of the conductive filler indicates smaller resistance and better conductivity. According to some implementations of this application, based on the mass of the conductive adhesive, the mass content of the conductive filler is 10%, 15%, 18%, 20%, 23%, 25%, 28%, 30%, 35%, 38%, 40%, 45%, or a value within a range of any two of the values.

According to some implementations of this application, based on a mass of the substrate, a mass content of the modified epoxy resin ranges from 70% to 90%. A higher proportion of the modified epoxy resin indicates a higher shear strength. According to some implementations of this application, based on the mass of the substrate, the mass content of the modified epoxy resin is 70%, 72%, 75%, 77%, 80%, 83%, 85%, 88%, 90%, or a value within a range of any two of the values.

According to some implementations of this application, based on the mass of the substrate, a mass content of the polyurethane ranges from 5% to 20%. A higher proportion of the polyurethane indicates higher impact damage resistance performance, and better vibration absorption effect of the conductive adhesive, so that vibration, dropping, and rolling resistance performance of the electrochemical apparatus can be further improved.

According to some implementations of this application, based on the mass of the substrate, a mass content of the polyimide ranges from 5% to 20%. A higher polyimide proportion indicates better temperature resistance performance of the conductive adhesive, so that high temperature safety performance of the electrochemical apparatus can be further improved.

According to some implementations of this application, at least one of the following conditions (x) to (z) is met: (x) a weight-average molecular weight of the modified epoxy resin ranges from 300 to 8000; (y) a weight-average molecular weight of the polyurethane ranges from 10000 to 150000; and (z) a weight-average molecular weight of the polyimide ranges from 13000 to 200000. According to some implementations of this application, the weight-average molecular weight of the modified epoxy resin is 500, 1000, 2000, 3000, 3500, 4000, 5000, 6000, 7000, or a value within a range of any two of the values. According to some implementations of this application, the weight-average molecular weight of the polyurethane is 10000, 20000, 30000, 40000, 50000, 60000, 70000, 80000, 90000, 100000, 130000, 150000, or a value within a range of any two of the values. According to some implementations of this application, the weight-average molecular weight of the polyimide is 13000, 20000, 40000, 50000, 80000, 100000, 120000, 150000, 180000, 200000, or a value within a range of any two of the values.

According to some implementations of this application, the conductive filler includes one or more of Au, Ag, Ni, Cu, Zn, graphite, or graphene.

According to some implementations of this application, the conductive filler satisfies at least one of the following conditions (i) to (iii): (i) a surface shape of the conductive filler includes one or more of a sheet shape, a spherical shape, or a dendritic shape; (ii) a particle size of the conductive filler ranges from 0.1 μm to 100 μm; and (iii) a stacking density of the conductive filler ranges from 2 g/cm³ to 15 g/cm³. By regulating the surface shape, particle size distribution, and the stacking density of the conductive filler, conductivity of the conductive adhesive can be improved, thereby improving the quality of the electrochemical apparatus. According to some preferred implementations of this application, the surface shape of the conductive filler is the spherical shape.

According to some implementations of this application, the conductive adhesive further includes other ingredients, and the other ingredients include one or more of a curing agent, a diluting agent, a promoter, a stress modifier, or a filler.

According to some implementations of this application, the curing agent includes one or more of an aromatic amine curing agent, a fatty amine curing agent, an alicyclic amine curing agent, a polyether amine curing agent, or an acid anhydride curing agent. According to some implementations of this application, the diluting agent includes one or more of toluene, xylene, benzene, or acetone. According to some implementations of this application, the stress modifier includes one or more of polysulfide rubber, ethylene resin, and nitrile rubber. According to some implementations of this application, the promoter includes one or more of diglycidyl ether, polyglycidyl ether, butyl glycidyl ether, phenyl glycidyl ether, dipropylene oxide ethyl ether, or tripropylene oxide propyl ether. According to some implementations of this application, the filler includes one or more of aluminum oxide, boron nitride, silicon oxide, or titanium oxide.

According to some implementations of this application, based on the mass of the conductive adhesive, a mass content of the other ingredients is ≤15%. According to some implementations of this application, based on the mass of the conductive adhesive, the mass content of the other ingredients is ≤10%.

According to some implementations of this application, the conductive adhesive has at least one of the following characteristics (a) to (e): (a) viscosity of the conductive adhesive ranges from 50 Pa·s to 300 Pa·s; (b) a thixotropic index of the conductive adhesive ranges from 1 to 5; (c) a curing temperature of the conductive adhesive is ≤150° C.; (d) an adhesive line width change rate of the conductive adhesive is ≤75%; and (e) a thermal weight loss rate of the conductive adhesive is ≤0.2%. According to some implementations of this application, the viscosity is measured according to a viscosity measurement method in GB/T 10247-2008 at a temperature of 200° C. and a rotation speed of 1 r/min. The thixotropic index is a ratio of viscosity at different rotation speeds, namely, a ratio of viscosity at a low speed (such as 0.1 r/min) to viscosity at a high speed (such as 1 r/min), and reflects a capability of a fluid to recover an original structure after the structure is destroyed under an action of a shear force. According to some implementations of this application, the thixotropic index is a ratio of viscosity at the rotation speed of 0.1 r/min to viscosity at the rotation speed of 1 r/min at a test temperature of 200° C. The adhesive line width change rate of the conductive adhesive is a width change rate of the conductive adhesive before and after curing, that is, Adhesive line width change rate=(Width after curing ˜Width before curing)/Width before curing×100%.

According to some implementations of this application, the conductive adhesive has at least one of the following characteristics (A) to (G): (A) a tensile shear bonding strength of the conductive adhesive ranges from 5 MPa to 10 MPa; (B) volume resistance of the conductive adhesive ranges from 0.01 Ω·cm to 0.1 Ω·cm; (C) contact resistance of the conductive adhesive is ≤0.5 Ω·cm; (D) total resistance of the conductive adhesive is ≤1 mΩ; (E) an electrolyte solution swelling ratio of the conductive adhesive is ≤0.1%; and (F) an electrolyte solution dissolution rate of the conductive adhesive is ≤2%.

In this application, the electrolyte solution swelling ratio represents a weight change rate of the conductive adhesive before and after immersion in an electrolyte solution solvent, and a calculation formula may be: Swelling ratio=(Weight after immersion ˜Weight before immersion)/Weight before immersion×100%. The electrolyte solution dissolution rate represents a weight change rate of the conductive adhesive before and after immersion in the electrolyte solution solvent and drying, and a calculation formula may be: Dissolution rate=(Weight before immersion ˜Weight after drying)/Weight before immersion×100%. An immersion temperature may range from 50° C. to 70° C., and immersion time may range from 5 to 8 days. Drying time may range from 5 to 8 days, and a drying temperature may range from 80° C. to 90° C. The electrolyte solution solvent includes ethylene carbonate (EC), propylene carbonate (PC), diethyl carbonate (DEC), and ethyl propionate (EP), and a mass ratio is, for example, EC:PC:DEC:EP=3:1:3:3.

According to a second aspect, this application provides an electrochemical apparatus. The electrochemical apparatus includes an electrode assembly and a shell. The shell is provided with a terminal, the electrode assembly is provided with a tab, and the terminal and the tab are connected by using the conductive adhesive according to the first aspect of this application.

According to a third aspect, this application provides an electronic apparatus including the electrochemical apparatus according to the second aspect of this application.

The conductive adhesive provided in this application has a high shear strength after bonding, and can ensure the reliability of the bonding interface; and also has stable electrochemical performance, and can meet a usage requirement of a lithium-ion battery. The conductive adhesive provided in this application replaces laser welding and is used in the electrochemical apparatus, so that production efficiency of the electrochemical apparatus can be improved, and costs are reduced.

### BRIEF DESCRIPTION OF DRAWINGS

Figure shows a schematic diagram of application positions of a conductive adhesive in a button battery according to an implementation of this application. In the Figure, 1 is a shell cover, 2 is a PP adhesive, 3 is a terminal, 4 is a conductive adhesive, 5 is a bare cell, and 6 is a shell.

### DETAILED DESCRIPTION

This application is further elaborated below in combination with the specific implementations. It should be understood that these specific implementations are only used to illustrate this application.

According to a first aspect, this application provides a conductive adhesive, including a substrate and a conductive filler, where the substrate includes modified epoxy resin, polyurethane, and polyimide.

In this application, the substrate in the conductive adhesive may form a molecular skeleton of the conductive adhesive, provide mechanical performance and a bonding function, and enable conductive filler particles to form channels. The conductive filler particles contact each other, and a tunnel effect enables the particles to form the current channels. The substrate in this application includes three constituents: the modified epoxy resin, the polyurethane, and the polyimide. The modified epoxy resin can resolve shortcomings such as high brittleness and poor toughness of epoxy resin. The polyurethane improves impact damage resistance performance and has a good vibration absorption effect. The polyimide can withstand a high temperature up to 400° C. and can be used for long time at 200° C. to 300° C.

The polyurethane, of which full name is polyurethane PU, refers to a heterochain polymer with —NH—COO— characteristic groups, and is synthesized from the following two raw materials: (1) isocyanate, which serves as a hard segment, includes two or more —NCO characteristic groups, has a highly unsaturated bond structure with an arrangement of overlapping double bonds, can react with various compounds including active hydrogen, and is, for example, hexamethylene diisocyanate (MDI) or naphthalene diisocyanate (NDI); and (2) polyol, which serves as a soft segment, and is, for example, butanediol, polyetherdiol, or polyesterdiol. By adjusting proportions and types of the soft segment and hard segment, a glass transition temperature, a melting point, a modulus, an elasticity, a tensile strength, and the like of the polyurethane can be controlled. According to some implementations of this application, the polyurethane includes the soft segment including the polyetherdiol or the polyesterdiol and the hard segment including isocyanate. According to some implementations of this application, the weight-average molecular weight of the polyurethane ranges from 10,000 to 150,000.

The polyimide is a condensation polymer of dianhydride and diamine, refers to a polymer of which main chain includes —CO—NH—CO— characteristic groups, is resistant to a high temperature, and can be used for long time at 200° C. to 300° C. According to some implementations of this application, the weight-average molecular weight of the polyimide ranges from 13,000 to 200,000.

According to some implementations of this application, the modified epoxy resin includes carboxyl and/or cyano. The active functional group carboxyl may react with an epoxy group in the epoxy resin. The cyano (—CN group) has strong polarity, and can have good miscibility with the epoxy resin. The epoxy resin is a type of a high molecular polymer, refers to a generic term of a type of polymers that include more than two epoxy groups in a molecule, is a condensation product of epichlorohydrin and bisphenol A or polyol, and has a weight-average molecular weight of 300 to 7,000.

According to some implementations of this application, the modified epoxy resin is an epoxy resin toughened with liquid carboxyl-terminated butadiene acrylonitrile (CTBN) rubber.

According to some implementations of this application, based on a mass of the conductive adhesive, a mass content of the substrate ranges from 50% to 85%. A higher mass proportion of the substrate indicates higher viscosity, a larger thixotropic index, and a larger shear strength of the conductive adhesive. Increased shear strength of the conductive adhesive can improve reliability of a bonding interface and further improve conductivity performance of the electrochemical apparatus. According to some implementations of this application, based on the mass of the conductive adhesive, the mass content of the substrate is 55%, 60%, 62%, 65%, 68%, 70%, 72%, 75%, 78%, 80%, 82%, 85%, or a value within a range of any two of the values.

According to some implementations of this application, based on the mass of the conductive adhesive, a mass content of the conductive filler ranges from 10% to 45%. A higher mass proportion of the conductive filler indicates smaller resistance and better conductivity. According to some implementations of this application, based on the mass of the conductive adhesive, the mass content of the conductive filler is 10%, 15%, 18%, 20%, 23%, 25%, 28%, 30%, 35%, 38%, 40%, 45%, or a value within a range of any two of the values.

According to some implementations of this application, based on a mass of the substrate, a mass content of the modified epoxy resin ranges from 70% to 90%. A higher proportion of the modified epoxy resin indicates a higher shear strength. According to some implementations of this application, based on the mass of the substrate, the mass content of the modified epoxy resin is 70%, 72%, 75%, 77%, 80%, 83%, 85%, 88%, 90%, or a value within a range of any two of the values.

According to some implementations of this application, based on the mass of the substrate, a mass content of the polyurethane ranges from 5% to 20%. A higher proportion of the polyurethane indicates higher impact damage resistance performance, and a better vibration absorption effect of the conductive adhesive, so that vibration, dropping, and rolling resistance performance of the electrochemical apparatus can be further improved.

According to some implementations of this application, based on the mass of the substrate, a mass content of the polyimide ranges from 5% to 20%. A higher polyimide proportion indicates better temperature resistance performance of the conductive adhesive, so that high temperature safety performance of the electrochemical apparatus can be further improved.

According to some implementations of this application, at least one of the following conditions (x) to (z) is met: (x) a weight-average molecular weight of the modified epoxy resin ranges from 300 to 8000; (y) a weight-average molecular weight of the polyurethane ranges from 10000 to 150000; and (z) a weight-average molecular weight of the polyimide ranges from 13000 to 200000. According to some implementations of this application, the weight-average molecular weight of the modified epoxy resin is 500, 1000, 2000, 3000, 3500, 4000, 5000, 6000, 7000, or a value within a range of any two of the values. According to some implementations of this application, the weight-average molecular weight of the polyurethane is 10000, 20000, 30000, 40000, 50000, 60000, 70000, 80000, 90000, 100000, 130000, 150000, or a value within a range of any two of the values. According to some implementations of this application, the weight-average molecular weight of the polyimide is 13000, 20000, 40000, 50000, 80000, 100000, 120000, 150000, 180000, 200000, or a value within a range of any two of the values.

According to some implementations of this application, the conductive filler includes one or more of Au, Ag, Ni, Cu, Zn, graphite, or graphene.

According to some implementations of this application, the conductive filler satisfies at least one of the following conditions (i) to (iii): (i) a surface shape of the conductive filler includes one or more of a sheet shape, a spherical shape, or a dendritic shape; (ii) a particle size of the conductive filler ranges from 0.1 μm to 100 μm; and (iii) a stacking density of the conductive filler ranges from 2 g/cm³ to 15 g/cm³. By regulating the surface shape, particle size distribution, and the stacking density of the conductive filler, conductivity of the conductive adhesive can be improved, thereby improving quality of the electrochemical apparatus. According to some preferred implementations of this application, the surface shape of the conductive filler is the spherical shape.

According to some implementations of this application, the conductive adhesive further includes other ingredients, and the other ingredients include one or more of a curing agent, a diluting agent, a promoter, a stress modifier, or a filler.

According to some implementations of this application, the curing agent includes one or more of an aromatic amine curing agent, a fatty amine curing agent, an alicyclic amine curing agent, a polyether amine curing agent, or an acid anhydride curing agent. According to some implementations of this application, the diluting agent includes one or more of toluene, xylene, benzene, or acetone. According to some implementations of this application, the stress modifier includes one or more of polysulfide rubber, ethylene resin, and nitrile rubber. According to some implementations of this application, the promoter includes one or more of diglycidyl ether, polyglycidyl ether, butyl glycidyl ether, phenyl glycidyl ether, dipropylene oxide ethyl ether, or tripropylene oxide propyl ether. According to some implementations of this application, the filler includes one or more of aluminum oxide, boron nitride, silicon oxide, or titanium oxide.

According to some implementations of this application, based on the mass of the conductive adhesive, a mass content of the other ingredients is ≤15%. According to some implementations of this application, based on the mass of the conductive adhesive, the mass content of the other ingredients is ≤10%.

According to some implementations of this application, the conductive adhesive has at least one of the following characteristics (a) to (e): (a) viscosity of the conductive adhesive ranges from 50 Pa·s to 300 Pa·s; (b) a thixotropic index of the conductive adhesive ranges from 1 to 5; (c) a curing temperature of the conductive adhesive is ≤150° C.; (d) an adhesive line width change rate is ≤75%; and (e) a thermal weight loss rate of the conductive adhesive is ≤0.2%. According to some implementations of this application, the viscosity is measured according to a viscosity measurement method in GB/T 10247-2008 at a temperature of 200° C. and a rotation speed of 1 r/min. The thixotropic index is a ratio of viscosity at different rotation speeds, namely, a ratio of viscosity at a low speed (such as 0.1 r/min) to viscosity at a high speed (such as 1 r/min), and reflects a capability of a fluid to recover an original structure after the structure is destroyed under an action of a shear force. According to some implementations of this application, the thixotropic index is a ratio of viscosity at the rotation speed of 0.1 r/min to viscosity at the rotation speed of 1 r/min at a test temperature of 200° C. The adhesive line width change rate is a width change rate of the conductive adhesive before and after curing, that is, Adhesive line width change rate=(Width after curing ˜Width before curing)/Width before curing×100%.

According to some implementations of this application, the conductive adhesive has at least one of the following characteristics (A) to (G): (A) a tensile shear bonding strength of the conductive adhesive ranges from 5 MPa to 10 MPa; (B) volume resistance of the conductive adhesive ranges from 0.01 Ω·cm to 0.1 Ω·cm; (C) contact resistance of the conductive adhesive is ≤0.5 Ω·cm; (D) total resistance of the conductive adhesive is ≤1 mΩ; (E) an electrolyte solution swelling ratio of the conductive adhesive is ≤0.1%; and (F) an electrolyte solution dissolution rate of the conductive adhesive is ≤2%.

In this application, the electrolyte solution swelling ratio represents a weight change rate of the conductive adhesive before and after immersion in an electrolyte solution solvent, and a calculation formula may be: Swelling ratio=(Weight after immersion—Weight before immersion)/Weight before immersion×100%. The electrolyte solution dissolution rate represents a weight change rate of the conductive adhesive after immersion in the electrolyte solution solvent and drying, and a calculation formula may be: Dissolution rate=(Weight before immersion−Weight after drying)/Weight before immersion×100%. An immersion temperature may range from 50° C. to 70° C., and immersion time may range from 5 to 8 days. Drying time may range from 5 to 8 days, and a drying temperature may range from 80° C. to 90° C. The electrolyte solution solvent includes ethylene carbonate (EC), propylene carbonate (PC), diethyl carbonate (DEC), and ethyl propionate (EP), and a mass ratio is, for example, EC:PC:DEC:EP=3:1:3:3.

The conductive adhesive provided in this application is cured below 150° C. After vertical dispensing is performed, an adhesive line does not slide downward or spread out, which ensures that there is a gap between adhesive lines and ensures that lithium ions between a tab and a terminal can freely pass, to meet a requirement in a dispensing processing process.

According to a second aspect, this application provides an electrochemical apparatus. The electrochemical apparatus includes an electrode assembly and a shell. The shell is provided with a terminal, the electrode assembly is provided with a tab, and the terminal and the tab are connected by using the conductive adhesive according to the first aspect of this application.

According to a third aspect, this application provides an electronic apparatus including the electrochemical apparatus according to the second aspect of this application.

The electronic device or apparatus in this application is not particularly limited. In some embodiments, the electronic device in this application includes, but is not limited to, a laptop computer, a pen-input computer, a mobile computer, an e-book player, a portable telephone, a portable fax, a portable photocopier, a portable printer, a head-mounted stereo headset, a video tape recorder, a liquid crystal display television, a handheld cleaner, a portable CD player, a minidisc, a transceiver, an electronic notebook, a calculator, a memory card, a portable tape recorder, a radio, a back-up power supply, an electric motor, an automobile, a motorcycle, a power-assisted bicycle, a bicycle, a lighting apparatus, a toy, a game console, a clock, an electronic tool, a flashing light, a camera, or a large storage battery for household use.

This application is further elaborated below with reference to embodiments. It should be understood that these embodiments are only used to illustrate this application and are not intended to limit the scope of this application.

### I) Test Method

1. Viscosity measurement method GB/T 10247-2008

Device name: Viscometer, Manufacturer: Brookfield, Model: DV2T, Measurement range: >1.5 mpa·s, and Accuracy: ±1% FS.

Rotation method to test viscosity: Place a conductive adhesive in a cylinder at a temperature of 200° C., and use a Brookfield 51 # rotor with a rotation speed of 1 rpm. Start the viscometer, wait and obtain a stable reading, and repeat the measurement three times. A maximum difference between three measurement values and an average value is not to exceed 1.5% of the average value. Take the average value of the three measurement values as a final viscosity result.

### 2. Thixotropic Index Test

A thixotropic index is a ratio of viscosity at different rotation speeds, namely, a ratio of viscosity at a low speed to viscosity at a high speed, and reflects a capability of a fluid to recover an original structure after the structure is destroyed under an action of a shear force.

Device name: Viscometer, Manufacturer: Brookfield, Model: DV2T, Measurement range: >1.5 mpa·s, and Accuracy: ±1% FS.

Test steps:
a) Place a container containing a test sample into a constant temperature bath that has been heated to 200° C. and keep the temperature uniform.
b) Vertically immerse a part of a Brookfield 51 # rotor in the test sample, and ensure that a liquid level reaches a rotor liquid level mark.
c) Set a rotation speed to be 0.1 r/min, start the viscometer, and take the first reading that is after a rotating pointer stabilizes. Turn off a motor and then restart twice. Separately take the second and third readings that are after the pointer stabilizes. Take an average value as η0.1.
d) Change the rotation speed from 0.1 r/min to 1 r/min, repeat the above steps, separately obtain, through measurement, three readings that are after the pointer stabilizes, and take an average value as η1.

The thixotropic index TI is to be calculated according to the following formula, where two significant figures are taken, and an experimental temperature is to be noted:

$$TI = η0 \text{.1} / η1$$

### 3. Shear Test

A shear strength is a maximum load, parallel to an adhesive surface, against which an adhesive joint can resist per unit area. Test steps:

prepare three types of test samples (an Al sheet, a Cu sheet, and a Ni sheet) in a sheet specification of 12.7 mm×25.4 mm, select three sample combinations: the Al sheet and the Cu sheet, the Al sheet and the Ni sheet, and the Cu sheet and the Ni sheet, and separately coat conductive adhesives at intermediate interfaces thereof. After curing at 100° C. for 2 hours, carry out the test at a tensile and shear speed of 10 mm/min on a universal testing machine until the interface is broken. Test five samples in each test sample combination, and take an arithmetic average value of tensile shear strengths as the shear strength of the bonded conductive adhesive.

### 4. Resistance Test Method

Four-probe resistivity tester, Manufacturer: Rec, and Model: FT-340. Tips of four probes are in a same straight line, and are at equal spacing S that is generally 0.5 mm, and measurement results need to be correspondingly corrected based on different probe spacing. By setting a thickness value, effects of different sample thicknesses on resistivity are calculated.

Specific steps for volume resistance: put a conductive adhesive into a 202.54 mm mold with a depth of 50 μm, put the test sample into color-changing and water-absorbing silica gel particles to cure for 2 h at 100° C., buckle the test sample upside down on a self-made four-probe mold, and press the test sample down to enable the probes and an adhesive strip to be in close contact, so as to obtain a resistance value to obtain the volume resistance through calculation.

Specific steps for contact resistance: coat a fitting part between an Al sheet and a Cu sheet with a 202 mm conductive adhesive, cure for 2 h at 100° C., and mark test areas on the Al sheet and Cu sheet respectively to measure resistance values.

Specific steps of total resistance: coat a conductive adhesive between a tab and a terminal of a bare cell to obtain a 202 mm test sample with a thickness of 50 μm to measure a resistance value.

### 5. Thermal Weight Loss Test Method

Device name: Thermal mass spectrometer DSC/TG-MS, Model: STA449F3-QMS403C, Test basis: GB/T 13464-2008 Thermal analysis method for thermal stability of substances, and Detection capacity: Room temperature ˜800° C., heating rate 0.1˜50° C./min, and TG resolution 0.1 ug.

Specific steps: the heating rate is 50° C./min, rise to 100° C., maintain for 2.5 h, and test thermal loss.

### 6. Dissolution Rate Test

Make a conductive adhesive into an adhesive block and soak the adhesive block in a lithium-free electrolyte solution to ensure that the adhesive block is completely immersed in the electrolyte solution. Soak at 60° C. for seven days and bake at 85° C. for seven days.

An organic solvent of the lithium-free electrolyte solution is ethylene carbonate (EC), propylene carbonate (PC), diethyl carbonate (DEC), and ethyl propionate (EP), and a mass ratio EC:PC:DEC:EP=3:1:3:3.

$$Swelling ratio = ( Weight after seven days of soaking - Weight before soaking ) / Weight before soaking * 100 \%$$

$$Dissolution rate = ( Weight before soaking - weight after drying / Weight before soaking * 100 \%$$

### 7. Adhesive Line Width Change Rate

A dispensing machine dispenses a conductive adhesive on a glass sheet. Stand at a room temperature for 10 min to ensure that viscosity of an adhesive line is stable. A CCD records an adhesive line width before curing.

Cure for 2 h at 100° C., to ensure that the adhesive line remains vertical in an entire curing process. The adhesive line width changes under gravity, and the CCD records a measured adhesive line width.

$$Adhesive line width change rate = ( Width after curing - Width before curing ) / Width before curing \times 100 \% .$$

### II) Embodiment and Comparative Embodiment

### 1. Preparation of a Conductive Adhesive

1). Pre-reaction: CTBN (carboxyl-terminated butadiene acrylonitrile) accounting for 10% to 15% in a mass proportion and epoxy resin (with a weight-average molecular weight of 3500) accounting for 85% to 90% in the mass proportion are put into a reactor, heated to 150° C., and stirred for 12 h in a protective atmosphere of N₂.

Mechanism: The CTBN is a telechelic polymer; has a molecular chain of which two ends are active functional group carboxyl, and can react with an epoxy group in the epoxy resin; and has a —CN group with highly polarity, and has good miscibility with the epoxy resin.

2). A curing agent (such as an aromatic amine curing agent, a fatty amine curing agent, an alicyclic amine curing agent, a polyetheramine curing agent, or an acid anhydride curing agent) is added to an “epoxy-CTBN-epoxy” adduct generated in the pre-reaction, and cured for 2 h to obtain a modified epoxy resin.

3). The modified epoxy resin accounting for 50% to 85% in the mass proportion, polyurethane (with a weight-average molecular weight of 80,000), and polyimide (with a weight-average molecular weight of 10,000) are added into the reactor in a mass ratio of (70% to 90%):(5% to 20%):(5% to 20%), a conductive filler (one or more of Au, Ag, Ni, Cu, Al, Zn, graphite, or graphene) accounting for 10% to 45% in the mass proportion is added, the temperature is increased to 200° C., and stirring is performed for 12 h in the protective atmosphere of N₂.

4). Then other ingredients (a curing agent, a diluting agent, a stress modifier, a promoter, or oxide) accounting for 5% to 10% in the mass proportion are added, and cured for 2 h to obtain the conductive adhesive.

For specific components of embodiments and comparative embodiments, refer to Table 1.

### 2. Preparation Method of a Battery

Positive electrode plate: positive active materials lithium cobalt oxide, acetylene black, and polyvinylidene fluoride (PVDF) are mixed in a mass ratio of 94:3:3, and N-methylpyrrolidone (NMP) is added as a solvent, to prepare a slurry with a solid content of 75% and the slurry is stirred evenly. The slurry is evenly coated on Al foil of a positive current collector and dried at 90° C., and after cold pressing, a positive electrode plate with a positive active material layer of which thickness is 100 μm is obtained. Then the above steps are repeated on the other surface of the positive electrode plate, to obtain a positive electrode plate coated with positive active material layers on both sides.

Negative electrode plate: negative active materials artificial graphite, acetylene black, styrene-butadiene rubber and sodium carboxymethyl cellulose are mixed in a mass ratio of 96:1:1.5:1.5, and deionized water is added as a solvent, to prepare a slurry with a solid content of 70%, and the slurry is stirred evenly. The slurry is evenly coated on copper foil of a negative current collector, dry at 110° C., and after cold pressing, a negative electrode plate with a one-side coated negative active material layer of which thickness is 150 μm is obtained, and then the above coating steps are repeated on the other surface of the negative electrode plate, to obtain a negative electrode plate coated with negative active material layers on both sides. Separator: PE separator with a thickness of 7 μm.

An organic solvent of an electrolyte solution is ethylene carbonate (EC), propylene carbonate (PC), diethyl carbonate (DEC), and ethyl propionate (EP), a mass ratio EC:PC:DEC:EP=3:1:3:3, a solute is lithium hexafluorophosphate (LiPF₆), and a concentration of LiPF₆ is 1 mol/L.

Battery preparation: the above-mentioned positive electrode plate and negative electrode plate are put on both sides of the separator, and winding is performed to obtain a bare cell. The bare cell is put into a steel shell, and a tab and a terminal of the bare cell are connected and fixed by using a conductive adhesive (specifically, a dispensing machine sprays or coats a specific quantity of the above-mentioned prepared conductive adhesive at the tab of the cell, then the cell is put into the shell, and finally the terminal covers the tab, so that reliable bonding is formed when the conductive adhesive is cured). Then, a lithium-ion button battery is prepared through top and side sealing, vacuum baking, electrolyte injection, formation, capacity testing, degassing, and other processes.

### III) Test Result

Table 1 shows composition of conductive adhesives in Embodiment 1 to Embodiment 49 and Comparative Embodiment 1 to Comparative Embodiment 5. Table 2 shows performance test results of conductive adhesives in Embodiment 1 to Embodiment 49 and Comparative Embodiment 1 to Comparative Embodiment 5.

TABLE 1

| | Substrate | | | | | | | | |
|---|---|---|---|---|---|---|---|---|---|
| Embodiment | | Modified epoxy | Conductive filler | | | | | Other ingredients | |
| and | Total | resin:poly- | | Total | | Particle size | Stacking | Total | |
| Comparative | mass | urethane:poly- | | mass | Surface | distribution | density | mass | Curing |
| Embodiment | proportion | imide | Type | proportion | shape | D50, μm | g/cm³ | proportion | agent |
| Embodiment | 50% | 80:10:10 | Ni | 45% | Spherical | 30 | 6 | 5% | Aromatic |
| 1 | | | | | shape | | | | amine |
| | | | | | | | | | curing |
| | | | | | | | | | agent |
| Embodiment | 60% | 80:10:10 | Ni | 35% | Spherical | 30 | 6 | 5% | Aromatic |
| 2 | | | | | shape | | | | amine |
| | | | | | | | | | curing |
| | | | | | | | | | agent |
| Embodiment | 70% | 80:10:10 | Ni | 25% | Spherical | 30 | 6 | 5% | Aromatic |
| 3 | | | | | shape | | | | amine |
| | | | | | | | | | curing |
| | | | | | | | | | agent |
| Embodiment | 80% | 80:10:10 | Ni | 15% | Spherical | 30 | 6 | 5% | Aromatic |
| 4 | | | | | shape | | | | amine |
| | | | | | | | | | curing |
| | | | | | | | | | agent |
| Embodiment | 85% | 80:10:10 | Ni | 10% | Spherical | 30 | 6 | 5% | Aromatic |
| 5 | | | | | shape | | | | amine |
| | | | | | | | | | curing |
| | | | | | | | | | agent |
| Embodiment | 75% | 70:10:20 | Ni | 20% | Spherical | 30 | 6 | 5% | Aromatic |
| 6 | | | | | shape | | | | amine |
| | | | | | | | | | curing |
| | | | | | | | | | agent |
| Embodiment | 75% | 80:5:15 | Ni | 20% | Spherical | 30 | 6 | 5% | Aromatic |
| 7 | | | | | shape | | | | amine |
| | | | | | | | | | curing |
| | | | | | | | | | agent |
| Embodiment | 75% | 90:5:5 | Ni | 20% | Spherical | 30 | 6 | 5% | Aromatic |
| 8 | | | | | shape | | | | amine |
| | | | | | | | | | curing |
| | | | | | | | | | agent |
| Embodiment | 75% | 80:10:10 | Au | 20% | Spherical | 30 | 6 | 5% | Aromatic |
| 9 | | | | | shape | | | | amine |
| | | | | | | | | | curing |
| | | | | | | | | | agent |
| Embodiment | 75% | 80:10:10 | Ag | 20% | Spherical | 30 | 6 | 5% | Aromatic |
| 10 | | | | | shape | | | | amine |
| | | | | | | | | | curing |
| | | | | | | | | | agent |
| Embodiment | 75% | 80:10:10 | Ni | 20% | Spherical | 30 | 6 | 5% | Aromatic |
| 11 | | | | | shape | | | | amine |
| | | | | | | | | | curing |
| | | | | | | | | | agent |
| Embodiment | 75% | 80:10:10 | Cu | 20% | Spherical | 30 | 6 | 5% | Aromatic |
| 12 | | | | | shape | | | | amine |
| | | | | | | | | | curing |
| | | | | | | | | | agent |
| Embodiment | 75% | 80:10:10 | Al | 20% | Spherical | 30 | 2 | 5% | Aromatic |
| 13 | | | | | shape | | | | amine |
| | | | | | | | | | curing |
| | | | | | | | | | agent |
| Embodiment | 75% | 80:10:10 | Zn | 20% | Spherical | 30 | 6 | 5% | Aromatic |
| 14 | | | | | shape | | | | amine |
| | | | | | | | | | curing |
| | | | | | | | | | agent |
| Embodiment | 75% | 80:10:10 | Graphite | 20% | Spherical | 30 | 2 | 5% | Aromatic |
| 15 | | | | | shape | | | | amine |
| | | | | | | | | | curing |
| | | | | | | | | | agent |
| Embodiment | 75% | 80:10:10 | Graphene | 20% | Spherical | 30 | 2 | 5% | Aromatic |
| 16 | | | | | shape | | | | amine |
| | | | | | | | | | curing |
| | | | | | | | | | agent |
| Embodiment | 75% | 80:10:10 | Ni | 20% | Spherical | 30 | 6 | 5% | Aromatic |
| 17 | | | | | shape | | | | amine |
| | | | | | | | | | curing |
| | | | | | | | | | agent |
| Embodiment | 75% | 80:10:10 | Ni | 19% | Spherical | 30 | 6 | 6% | Aromatic |
| 18 | | | | | shape | | | | amine |
| | | | | | | | | | curing |
| | | | | | | | | | agent |
| Embodiment | 75% | 80:10:10 | Ni | 17% | Spherical | 30 | 6 | 8% | Aromatic |
| 19 | | | | | shape | | | | amine |
| | | | | | | | | | curing |
| | | | | | | | | | agent |
| Embodiment | 75% | 80:10:10 | Ni | 15% | Spherical | 30 | 6 | 10% | Aromatic |
| 20 | | | | | shape | | | | amine |
| | | | | | | | | | curing |
| | | | | | | | | | agent |
| Embodiment | 75% | 80:10:10 | Ni | 20% | Spherical | 80 | 6 | 5% | Aromatic |
| 21 | | | | | shape | | | | amine |
| | | | | | | | | | curing |
| | | | | | | | | | agent |
| Embodiment | 75% | 80:10:10 | Ni | 20% | Sheet | 80 | 6 | 5% | Aromatic |
| 22 | | | | | shape | | | | amine |
| | | | | | | | | | curing |
| | | | | | | | | | agent |
| Embodiment | 75% | 80:10:10 | Ni | 20% | Dendritic | 80 | 6 | 5% | Aromatic |
| 23 | | | | | shape | | | | amine |
| | | | | | | | | | curing |
| | | | | | | | | | agent |
| Embodiment | 75% | 80:10:10 | Ni | 20% | Spherical | 0.1 | 6 | 5% | Aromatic |
| 24 | | | | | shape | | | | amine |
| | | | | | | | | | curing |
| | | | | | | | | | agent |
| Embodiment | 75% | 80:10:10 | Ni | 20% | Spherical | 10 | 6 | 5% | Aromatic |
| 25 | | | | | shape | | | | amine |
| | | | | | | | | | curing |
| | | | | | | | | | agent |
| Embodiment | 75% | 80:10:10 | Ni | 20% | Spherical | 100 | 6 | 5% | Aromatic |
| 26 | | | | | shape | | | | amine |
| | | | | | | | | | curing |
| | | | | | | | | | agent |
| Embodiment | 75% | 80:10:10 | Ni | 20% | Spherical | 1000 | 6 | 5% | Aromatic |
| 27 | | | | | shape | | | | amine |
| | | | | | | | | | curing |
| | | | | | | | | | agent |
| Embodiment | 75% | 80:10:10 | Au | 20% | Spherical | 30 | 1 | 5% | Aromatic |
| 28 | | | | | shape | | | | amine |
| | | | | | | | | | curing |
| | | | | | | | | | agent |
| Embodiment | 75% | 80:10:10 | Au | 20% | Spherical | 30 | 2 | 5% | Aromatic |
| 29 | | | | | shape | | | | amine |
| | | | | | | | | | curing |
| | | | | | | | | | agent |
| Embodiment | 75% | 80:10:10 | Au | 20% | Spherical | 30 | 8 | 5% | Aromatic |
| 30 | | | | | shape | | | | amine |
| | | | | | | | | | curing |
| | | | | | | | | | agent |
| Embodiment | 75% | 80:10:10 | Au | 20% | Spherical | 30 | 15 | 5% | Aromatic |
| 31 | | | | | shape | | | | amine |
| | | | | | | | | | curing |
| | | | | | | | | | agent |
| Embodiment | 75% | 80:10:10 | Ni | 20% | Spherical | 30 | 6 | 5% | Fatty |
| 32 | | | | | shape | | | | amine |
| | | | | | | | | | curing |
| | | | | | | | | | agent |
| Embodiment | 75% | 80:10:10 | Ni | 20% | Spherical | 30 | 6 | 5% | Polyether |
| 33 | | | | | shape | | | | amine |
| | | | | | | | | | curing |
| | | | | | | | | | agent |
| Embodiment | 75% | 80:10:10 | Ni | 20% | Spherical | 30 | 6 | 5% | Acid |
| 34 | | | | | shape | | | | anhydride |
| | | | | | | | | | curing |
| | | | | | | | | | agent |
| Embodiment | 75% | 80:10:10 | Ni | 20% | Spherical | 30 | 6 | 5% | Aromatic |
| 35 | | | | | shape | | | | amine |
| | | | | | | | | | curing |
| | | | | | | | | | agent |
| Embodiment | 75% | 80:10:10 | Ni | 20% | Spherical | 30 | 6 | 5% | Aromatic |
| 36 | | | | | shape | | | | amine |
| | | | | | | | | | curing |
| | | | | | | | | | agent |
| Embodiment | 75% | 80:10:10 | Ni | 20% | Spherical | 30 | 6 | 5% | Aromatic |
| 37 | | | | | shape | | | | amine |
| | | | | | | | | | curing |
| | | | | | | | | | agent |
| Embodiment | 75% | 80:10:10 | Ni | 20% | Spherical | 30 | 6 | 5% | Aromatic |
| 38 | | | | | shape | | | | amine |
| | | | | | | | | | curing |
| | | | | | | | | | agent |
| Embodiment | 75% | 80:10:10 | Ni | 20% | Spherical | 30 | 6 | 5% | Aromatic |
| 39 | | | | | shape | | | | amine |
| | | | | | | | | | curing |
| | | | | | | | | | agent |
| Embodiment | 75% | 80:10:10 | Ni | 20% | Spherical | 30 | 6 | 5% | Aromatic |
| 40 | | | | | shape | | | | amine |
| | | | | | | | | | curing |
| | | | | | | | | | agent |
| Embodiment | 75% | 80:10:10 | Ni | 20% | Spherical | 30 | 6 | 5% | Aromatic |
| 41 | | | | | shape | | | | amine |
| | | | | | | | | | curing |
| | | | | | | | | | agent |
| Embodiment | 75% | 80:10:10 | Ni | 20% | Spherical | 30 | 6 | 5% | Aromatic |
| 42 | | | | | shape | | | | amine |
| | | | | | | | | | curing |
| | | | | | | | | | agent |
| Embodiment | 75% | 80:10:10 | Ni | 20% | Spherical | 30 | 6 | 5% | Aromatic |
| 43 | | | | | shape | | | | amine |
| | | | | | | | | | curing |
| | | | | | | | | | agent |
| Embodiment | 75% | 80:10:10 | Ni | 20% | Spherical | 30 | 6 | 5% | Aromatic |
| 44 | | | | | shape | | | | amine |
| | | | | | | | | | curing |
| | | | | | | | | | agent |
| Embodiment | 75% | 60:20:20 | Ni | 20% | Spherical | 30 | 6 | 5% | Aromatic |
| 45 | | | | | shape | | | | amine |
| | | | | | | | | | curing |
| | | | | | | | | | agent |
| Embodiment | 75% | 80:20:0 | Ni | 20% | Spherical | 30 | 6 | 5% | Aromatic |
| 46 | | | | | shape | | | | amine |
| | | | | | | | | | curing |
| | | | | | | | | | agent |
| Embodiment | 75% | 80:0:20 | Ni | 20% | Spherical | 30 | 6 | 5% | Aromatic |
| 47 | | | | | shape | | | | amine |
| | | | | | | | | | curing |
| | | | | | | | | | agent |
| Embodiment | 40% | 80:10:10 | Ni | 45% | Spherical | 30 | 6 | 15% | Aromatic |
| 48 | | | | | shape | | | | amine |
| | | | | | | | | | curing |
| | | | | | | | | | agent |
| Embodiment | 95% | 80:10:10 | Ni | 2% | Spherical | 30 | 6 | 3% | Aromatic |
| 49 | | | | | shape | | | | amine |
| | | | | | | | | | curing |
| | | | | | | | | | agent |
| Comparative | 75% | Epoxy resin:poly- | Ni | 20% | Spherical | 30 | 6 | 5% | Aromatic |
| Embodiment | | urethane:poly- | | | shape | | | | amine |
| 1 | | imide = 100:0:0 | | | | | | | curing |
| | | | | | | | | | agent |
| Comparative | 75% | Modified epoxy | Ni | 20% | Spherical | 30 | 6 | 5% | Aromatic |
| Embodimen | | resin:poly- | | | shape | | | | amine |
| | | urethane:poly- | | | | | | | curing |
| | | imide = 100:0:0 | | | | | | | agent |
| Comparative | 75% | 0:100:0 | Ni | 20% | Spherical | 30 | 6 | 5% | Aromatic |
| Embodiment | | | | | shape | | | | amine |
| 3 | | | | | | | | | curing |
| | | | | | | | | | agent |
| Comparative | 75% | 0:0:100 | Ni | 20% | Spherical | 30 | 6 | 5% | Aromatic |
| Embodiment | | | | | shape | | | | amine |
| 4 | | | | | | | | | curing |
| | | | | | | | | | agent |
| Comparative | 50% | Epoxy resin:poly- | Ni | 45% | Spherical | 30 | 6 | 5% | Aromatic |
| Embodiment | | urethane:poly- | | | shape | | | | amine |
| 5 | | imide = 80:10:10 | | | | | | | curing |
| | | | | | | | | | agent |

| Embodiment | | | | |
|---|---|---|---|---|
| and | Other ingredients | | | |
| Comparative | Diluting | Stress | | |
| Embodiment | agent | modifier | Promoter | Oxide |
| Embodiment | Toluene | Polysulfide | Diglycidyl | Aluminum |
| 1 | | rubber | ether | oxide |
| Embodiment | Toluene | Polysulfide | Diglycidyl | Aluminum |
| 2 | | rubber | ether | oxide |
| Embodiment | Toluene | Polysulfide | Diglycidyl | Aluminum |
| 3 | | rubber | ether | oxide |
| Embodiment | Toluene | Polysulfide | Diglycidyl | Aluminum |
| 4 | | rubber | ether | oxide |
| Embodiment | Toluene | Polysulfide | Diglycidyl | Aluminum |
| 5 | | rubber | ether | oxide |
| Embodiment | Toluene | Polysulfide | Diglycidyl | Aluminum |
| 6 | | rubber | ether | oxide |
| Embodiment | Toluene | Polysulfide | Diglycidyl | Aluminum |
| 7 | | rubber | ether | oxide |
| Embodiment | Toluene | Polysulfide | Diglycidyl | Aluminum |
| 8 | | rubber | ether | oxide |
| Embodiment | Toluene | Polysulfide | Diglycidyl | Aluminum |
| 9 | | rubber | ether | oxide |
| Embodiment | Toluene | Polysulfide | Diglycidyl | Aluminum |
| 10 | | rubber | ether | oxide |
| Embodiment | Toluene | Polysulfide | Diglycidyl | Aluminum |
| 11 | | rubber | ether | oxide |
| Embodiment | Toluene | Polysulfide | Diglycidyl | Aluminum |
| 12 | | rubber | ether | oxide |
| Embodiment | Toluene | Polysulfide | Diglycidyl | Aluminum |
| 13 | | rubber | ether | oxide |
| Embodiment | Toluene | Polysulfide | Diglycidyl | Aluminum |
| 14 | | rubber | ether | oxide |
| Embodiment | Toluene | Polysulfide | Diglycidyl | Aluminum |
| 15 | | rubber | ether | oxide |
| Embodiment | Toluene | Polysulfide | Diglycidyl | Aluminum |
| 16 | | rubber | ether | oxide |
| Embodiment | Toluene | Polysulfide | Diglycidyl | Aluminum |
| 17 | | rubber | ether | oxide |
| Embodiment | Toluene | Polysulfide | Diglycidyl | Aluminum |
| 18 | | rubber | ether | oxide |
| Embodiment | Toluene | Polysulfide | Diglycidyl | Aluminum |
| 19 | | rubber | ether | oxide |
| Embodiment | Toluene | Polysulfide | Diglycidyl | Aluminum |
| 20 | | rubber | ether | oxide |
| Embodiment | Toluene | Polysulfide | Diglycidyl | Aluminum |
| 21 | | rubber | ether | oxide |
| Embodiment | Toluene | Polysulfide | Diglycidyl | Aluminum |
| 22 | | rubber | ether | oxide |
| Embodiment | Toluene | Polysulfide | Diglycidyl | Aluminum |
| 23 | | rubber | ether | oxide |
| Embodiment | Toluene | Polysulfide | Diglycidyl | Aluminum |
| 24 | | rubber | ether | oxide |
| Embodiment | Toluene | Polysulfide | Diglycidyl | Aluminum |
| 25 | | rubber | ether | oxide |
| Embodiment | Toluene | Polysulfide | Diglycidyl | Aluminum |
| 26 | | rubber | ether | oxide |
| Embodiment | Toluene | Polysulfide | Diglycidyl | Aluminum |
| 27 | | rubber | ether | oxide |
| Embodiment | Toluene | Polysulfide | Diglycidyl | Aluminum |
| 28 | | rubber | ether | oxide |
| Embodiment | Toluene | Polysulfide | Diglycidyl | Aluminum |
| 29 | | rubber | ether | oxide |
| Embodiment | Toluene | Polysulfide | Diglycidyl | Aluminum |
| 30 | | rubber | ether | oxide |
| Embodiment | Toluene | Polysulfide | Diglycidyl | Aluminum |
| 31 | | rubber | ether | oxide |
| Embodiment | Toluene | Polysulfide | Diglycidyl | Aluminum |
| 32 | | rubber | ether | oxide |
| Embodiment | Toluene | Polysulfide | Diglycidyl | Aluminum |
| 33 | | rubber | ether | oxide |
| Embodiment | Toluene | Polysulfide | Diglycidyl | Aluminum |
| 34 | | rubber | ether | oxide |
| Embodiment | Xylene | Polysulfide | Diglycidyl | Aluminum |
| 35 | | rubber | ether | oxide |
| Embodiment | Benzene | Polysulfide | Diglycidyl | Aluminum |
| 36 | | rubber | ether | oxide |
| Embodiment | Acetone | Polysulfide | Diglycidyl | Aluminum |
| 37 | | rubber | ether | oxide |
| Embodiment | Toluene | Ethylene | Diglycidyl | Aluminum |
| 38 | | resin | ether | oxide |
| Embodiment | Toluene | Nitrile | Diglycidyl | Aluminum |
| 39 | | rubber | ether | oxide |
| Embodiment | Toluene | Polysulfide | Polyglycidyl | Aluminum |
| 40 | | rubber | ether | oxide |
| Embodiment | Toluene | Polysulfide | Butylglycidyl | Aluminum |
| 41 | | rubber | ether | oxide |
| Embodiment | Toluene | Polysulfide | Phenylglycidyl | Aluminum |
| 42 | | rubber | ether | oxide |
| Embodiment | Toluene | Polysulfide | Diglycidyl | Boron |
| 43 | | rubber | ether | nitride |
| Embodiment | Toluene | Polysulfide | Diglycidyl | Silicon |
| 44 | | rubber | ether | oxide |
| Embodiment | Toluene | Polysulfide | Diglycidyl | Aluminum |
| 45 | | rubber | ether | oxide |
| Embodiment | Toluene | Polysulfide | Diglycidyl | Aluminum |
| 46 | | rubber | ether | oxide |
| Embodiment | Toluene | Polysulfide | Diglycidyl | Aluminum |
| 47 | | rubber | ether | oxide |
| Embodiment | Toluene | Polysulfide | Diglycidyl | Aluminum |
| 48 | | rubber | ether | oxide |
| Embodiment | Toluene | Polysulfide | Diglycidyl | Aluminum |
| 49 | | rubber | ether | oxide |
| Comparative | Toluene | Polysulfide | Diglycidyl | Aluminum |
| Embodiment | | rubber | ether | oxide |
| 1 | | | | |
| Comparative | Toluene | Polysulfide | Diglycidyl | Aluminum |
| Embodimen | | rubber | ether | oxide |
| Comparative | Toluene | Polysulfide | Diglycidyl | Aluminum |
| Embodiment | | rubber | ether | oxide |
| 3 | | | | |
| Comparative | Toluene | Polysulfide | Diglycidyl | Aluminum |
| Embodiment | | rubber | ether | oxide |
| 4 | | | | |
| Comparative | Toluene | Polysulfide | Diglycidyl | Aluminum |
| Embodiment | | rubber | ether | oxide |
| 5 | | | | |

TABLE 2

| Embodiment | Rheological | | | Resistance | | | Thermal | | | Adhesive |
|---|---|---|---|---|---|---|---|---|---|---|
| and | characteristic | | Shear | Volume | Contact | Total | weight | | | line width |
| Comparative | Viscosity | Thixotropic | strength | resistance | resistance | resistance | loss | Swelling | Dissolution | change |
| Embodiment | Pa · s | index | MPa | Ω · cm | Ω · cm | mΩ | rate | ratio | rate | rate |
| Embodiment | 80.2 | 1.50 | 5.20 | 0.004 | 0.08 | 0.14 | 0.03% | 0.01% | 0.56% | 72% |
| 1 | | | | | | | | | | |
| Embodiment | 132.5 | 2.38 | 6.47 | 0.021 | 0.17 | 0.32 | 0.05% | 0.03% | 1.02% | 51% |
| 2 | | | | | | | | | | |
| Embodiment | 175.9 | 3.21 | 7.52 | 0.040 | 0.23 | 0.53 | 0.10% | 0.04% | 1.40% | 33% |
| 3 | | | | | | | | | | |
| Embodiment | 210.1 | 4.06 | 8.91 | 0.072 | 0.39 | 0.76 | 0.14% | 0.07% | 1.71% | 17% |
| 4 | | | | | | | | | | |
| Embodiment | 270.3 | 4.91 | 9.87 | 0.096 | 0.48 | 0.90 | 0.17% | 0.10% | 1.95% | 11% |
| 5 | | | | | | | | | | |
| Embodiment | 185.3 | 3.44 | 7.74 | 0.053 | 0.26 | 0.59 | 0.09% | 0.05% | 1.51% | 30% |
| 6 | | | | | | | | | | |
| Embodiment | 190.4 | 3.56 | 7.89 | 0.055 | 0.27 | 0.63 | 0.11% | 0.04% | 1.55% | 29% |
| 7 | | | | | | | | | | |
| Embodiment | 194.6 | 3.62 | 7.99 | 0.051 | 0.26 | 0.58 | 0.11% | 0.04% | 1.50% | 27% |
| 8 | | | | | | | | | | |
| Embodiment | 186.2 | 3.45 | 7.78 | 0.057 | 0.25 | 0.57 | 0.10% | 0.04% | 1.52% | 26% |
| 9 | | | | | | | | | | |
| Embodiment | 189.5 | 3.51 | 7.80 | 0.050 | 0.29 | 0.60 | 0.12% | 0.05% | 1.54% | 29% |
| 10 | | | | | | | | | | |
| Embodiment | 190.1 | 3.60 | 7.90 | 0.054 | 0.27 | 0.59 | 0.09% | 0.05% | 1.56% | 27% |
| 11 | | | | | | | | | | |
| Embodiment | 191.4 | 3.59 | 7.85 | 0.061 | 0.30 | 0.58 | 0.11% | 0.06% | 1.58% | 24% |
| 12 | | | | | | | | | | |
| Embodiment | 189.9 | 3.55 | 7.88 | 0.059 | 0.28 | 0.58 | 0.09% | 0.05% | 1.51% | 28% |
| 13 | | | | | | | | | | |
| Embodiment | 192.2 | 3.59 | 7.90 | 0.056 | 0.26 | 0.56 | 0.11% | 0.04% | 1.53% | 24% |
| 14 | | | | | | | | | | |
| Embodiment | 187.4 | 3.62 | 7.83 | 0.059 | 0.24 | 0.62 | 0.13% | 0.04% | 1.52% | 26% |
| 15 | | | | | | | | | | |
| Embodiment | 193.8 | 3.61 | 7.79 | 0.058 | 0.31 | 0.59 | 0.11% | 0.05% | 1.55% | 27% |
| 16 | | | | | | | | | | |
| Embodiment | 191.8 | 3.46 | 7.91 | 0.052 | 0.25 | 0.57 | 0.10% | 0.05% | 1.56% | 29% |
| 17 | | | | | | | | | | |
| Embodiment | 188.5 | 3.50 | 7.82 | 0.051 | 0.27 | 0.58 | 0.12% | 0.04% | 1.53% | 24% |
| 18 | | | | | | | | | | |
| Embodiment | 190.4 | 3.57 | 7.82 | 0.057 | 0.30 | 0.61 | 0.09% | 0.04% | 1.54% | 27% |
| 19 | | | | | | | | | | |
| Embodiment | 193.5 | 3.58 | 7.91 | 0.061 | 0.26 | 0.60 | 0.11% | 0.05% | 1.50% | 25% |
| 20 | | | | | | | | | | |
| Embodiment | 190.2 | 3.52 | 7.82 | 0.053 | 0.28 | 0.58 | 0.12% | 0.06% | 1.51% | 28% |
| 21 | | | | | | | | | | |
| Embodiment | 188.3 | 3.54 | 7.88 | 0.055 | 0.59 | 1.10 | 0.13% | 0.05% | 1.56% | 26% |
| 22 | | | | | | | | | | |
| Embodiment | 190.9 | 3.54 | 7.86 | 0.058 | 0.47 | 0.96 | 0.13% | 0.05% | 1.53% | 24% |
| 23 | | | | | | | | | | |
| Embodiment | 191.8 | 3.47 | 7.85 | 0.059 | 0.32 | 0.60 | 0.10% | 0.06% | 1.54% | 27% |
| 24 | | | | | | | | | | |
| Embodiment | 187.5 | 3.57 | 7.78 | 0.053 | 0.26 | 0.59 | 0.11% | 0.04% | 1.53% | 26% |
| 25 | | | | | | | | | | |
| Embodiment | 188.9 | 3.53 | 7.89 | 0.054 | 0.24 | 0.6 | 0.12% | 0.05% | 1.59% | 27% |
| 26 | | | | | | | | | | |
| Embodiment | 190.5 | 3.54 | 7.82 | 0.210 | 0.53 | 1.08 | 0.13% | 0.05% | 1.55% | 25% |
| 27 | | | | | | | | | | |
| Embodiment | 189.7 | 3.54 | 7.90 | 0.130 | 0.65 | 1.32 | 0.10% | 0.06% | 1.55% | 26% |
| 28 | | | | | | | | | | |
| Embodiment | 189.6 | 3.52 | 7.92 | 0.051 | 0.30 | 0.59 | 0.09% | 0.04% | 1.52% | 29% |
| 29 | | | | | | | | | | |
| Embodiment | 189.1 | 3.50 | 7.79 | 0.054 | 0.28 | 0.60 | 0.11% | 0.05% | 1.51% | 27% |
| 30 | | | | | | | | | | |
| Embodiment | 189.6 | 3.59 | 7.85 | 0.062 | 0.27 | 0.61 | 0.11% | 0.05% | 1.56% | 25% |
| 31 | | | | | | | | | | |
| Embodiment | 194.3 | 3.57 | 7.8 | 0.057 | 0.25 | 0.59 | 0.09% | 0.04% | 1.55% | 29% |
| 32 | | | | | | | | | | |
| Embodiment | 192.5 | 3.57 | 7.88 | 0.055 | 0.25 | 0.57 | 0.12% | 0.05% | 1.50% | 27% |
| 33 | | | | | | | | | | |
| Embodiment | 193.5 | 3.61 | 7.84 | 0.053 | 0.28 | 0.58 | 0.09% | 0.04% | 1.59% | 26% |
| 34 | | | | | | | | | | |
| Embodiment | 191.4 | 3.60 | 7.83 | 0.060 | 0.31 | 0.61 | 0.10% | 0.04% | 1.53% | 27% |
| 35 | | | | | | | | | | |
| Embodiment | 189.2 | 3.48 | 7.86 | 0.053 | 0.29 | 0.58 | 0.11% | 0.04% | 1.54% | 30% |
| 36 | | | | | | | | | | |
| Embodiment | 192.4 | 3.54 | 7.91 | 0.054 | 0.28 | 0.62 | 0.09% | 0.05% | 1.51% | 28% |
| 37 | | | | | | | | | | |
| Embodiment | 191.9 | 3.61 | 7.84 | 0.057 | 0.30 | 0.59 | 0.13% | 0.04% | 1.57% | 24% |
| 38 | | | | | | | | | | |
| Embodiment | 187.8 | 3.59 | 7.86 | 0.055 | 0.29 | 0.57 | 0.09% | 0.05% | 1.55% | 30% |
| 39 | | | | | | | | | | |
| Embodiment | 190.1 | 3.55 | 7.77 | 0.059 | 0.27 | 0.56 | 0.13% | 0.04% | 1.58% | 28% |
| 40 | | | | | | | | | | |
| Embodiment | 189.3 | 3.58 | 7.80 | 0.052 | 0.25 | 0.61 | 0.10% | 0.05% | 1.52% | 29% |
| 41 | | | | | | | | | | |
| Embodiment | 193.6 | 3.62 | 7.85 | 0.056 | 0.28 | 0.58 | 0.12% | 0.06% | 1.55% | 25% |
| 42 | | | | | | | | | | |
| Embodiment | 188.4 | 3.52 | 7.87 | 0.054 | 0.29 | 0.59 | 0.09% | 0.04% | 1.58% | 28% |
| 43 | | | | | | | | | | |
| Embodiment | 194.7 | 3.61 | 7.94 | 0.055 | 0.26 | 0.57 | 0.13% | 0.05% | 1.53% | 25% |
| 44 | | | | | | | | | | |
| Embodiment | 150.4 | 2.75 | 6.58 | 0.052 | 0.29 | 0.56 | 0.08% | 0.15% | 2.31% | 43% |
| 45 | | | | | | | | | | |
| Embodiment | 189.4 | 3.58 | 7.21 | 0.055 | 0.26 | 0.60 | 0.12% | 0.09% | 1.79% | 26% |
| 46 | | | | | | | | | | |
| Embodiment | 191.3 | 3.61 | 7.35 | 0.054 | 0.27 | 0.57 | 0.11% | 0.08% | 1.95% | 28% |
| 47 | | | | | | | | | | |
| Embodiment | 30.2 | 0.82 | 4.35 | 0.057 | 0.26 | 0.56 | 0.10% | 0.21% | 4.10% | 80% |
| 48 | | | | | | | | | | |
| Embodiment | 405.7 | 7.90 | 11.60 | 0.305 | 3.28 | 5.21 | 0.07% | 0.05% | 1.53% | 28% |
| 49 | | | | | | | | | | |
| Comparative | 342.1 | 6.41 | 10.80 | 0.063 | 0.51 | 1.22 | 0.12% | 0.05% | 1.50% | 22% |
| Embodiment 1 | | | | | | | | | | |
| Comparative | 328.5 | 5.98 | 11.20 | 0.061 | 0.34 | 1.10 | 0.13% | 0.06% | 1.56% | 27% |
| Embodiment 2 | | | | | | | | | | |
| Comparative | 316.6 | 5.85 | 7.20 | 0.063 | 0.66 | 1.21 | 1.20% | 145.85% | 62.68% | 138% |
| Embodiment 3 | | | | | | | | | | |
| Comparative | 310.2 | 5.47 | 7.50 | 0.062 | 0.57 | 1.58 | 0.93% | 8.26% | 4.51% | 119% |
| Embodiment 4 | | | | | | | | | | |
| Comparative | 68.5 | 1.31 | 2.80 | 0.019 | 0.12 | 0.95 | 0.58% | 0.12% | 1.63% | 81% |
| Embodiment 5 | | | | | | | | | | |

It can be seen from Table 1 and Table 2 that

1. When the total mass proportion of the substrate is 40%, the shear strength of the conductive adhesive is only 4.35 MPa, and cannot achieve reliable bonding. When the total mass proportion of the substrate is 95%, the thixotropic index of the conductive adhesive is 7.90, dispensing processability is poor, and the mass proportion of the conductive filler is low, resulting in large resistance. Therefore, when the mass proportion of the substrate ranges from 50% to 85%, a usage requirement can be satisfied.

2. It is seen from Embodiment 1 and Comparative Embodiment 5 that, the shear strength of the conductive adhesive can be increased from 2.80 MPa to 5.20 MPa, so that toughness of the modified epoxy resin is better than the epoxy resin. Therefore, the substrate needs to be the modified epoxy resin to meet a usage requirement.

3. When the substrate only has the epoxy resin or the modified epoxy resin, the viscosity of the conductive adhesive is high, the thixotropic index is large, and dispensing processability is poor.

4. When the substrate only has the polyurethane, the viscosity of the conductive adhesive is high, the thixotropic index is large, and dispensing processability is poor. In addition, the swelling ratio, dissolution rate, and adhesive line width change rate are all large, and there is an electrochemical risk.

5. When the substrate only has the polyimide, the viscosity of the conductive adhesive is high, the thixotropic index is large, and dispensing processability is poor. In addition, the swelling ratio, dissolution rate, and adhesive line width change rate are all large, and there is an electrochemical risk.

6. When composition of modified epoxy resin:polyurethane:polyimide=(70%-90%):(5%-20%):(5%-20%) in the substrate, reliable bonding of the conductive adhesive can be achieved.

The above embodiments are only used to illustrate the technical solutions of this application, not for limitation. Although this application is described in detail with reference to the above embodiments, persons of ordinary skill in the art should understand that they can still modify the technical solutions described in the above embodiments, or replace a part or all of the technical features thereof, and these modifications or replacements do not take the essence of the corresponding technical solution out of the scope of the technical solutions in this application.

What is claimed is:

1. A conductive adhesive, comprising a substrate and a conductive filler, wherein the substrate comprises modified epoxy resin, polyurethane, and polyimide.

2. The conductive adhesive according to claim 1, wherein based on a mass of the conductive adhesive, a mass content of the substrate ranges from 50% to 85%, and a mass content of the conductive filler ranges from 10% to 45%.

3. The conductive adhesive according to claim 1, wherein based on a mass of the substrate, a mass content of the modified epoxy resin ranges from 70% to 90%, a mass content of the polyurethane ranges from 5% to 20%, and a mass content of the polyimide ranges from 5% to 20%.

4. The conductive adhesive according to claim 1, wherein the modified epoxy resin comprises carboxyl and/or cyano.

5. The conductive adhesive according to claim 1, wherein the conductive filler comprises at least one selected from the group consisting of Au, Ag, Ni, Cu, Zn, graphite, and graphene.

6. The conductive adhesive according to claim 1, wherein the conductive filler satisfies at least one of the following conditions (i) to (iii):
(i) a surface shape of the conductive filler comprises one or more of a sheet shape, a spherical shape, or a dendritic shape;
(ii) a particle size of the conductive filler ranges from 0.1 μm to 100 μm; or
(iii) a stacking density of the conductive filler ranges from 2 g/cm³ to 15 g/cm³.

7. The conductive adhesive according to claim 1, wherein the conductive adhesive has at least one of the following characteristics (a) to (e):
(a) a viscosity of the conductive adhesive ranges from 50 Pa·s to 300 Pa·s;
(b) a thixotropic index of the conductive adhesive ranges from 1 to 5;
(c) a curing temperature of the conductive adhesive is ≤150° C.;
(d) an adhesive line width change rate of the conductive adhesive is ≤75%; or
(e) a thermal weight loss rate of the conductive adhesive is ≤0.2%.

8. The conductive adhesive according to claim 1, wherein the conductive adhesive has at least one of the following characteristics (A) to (F):
(A) a tensile shear bonding strength of the conductive adhesive ranges from 5 MPa to 10 MPa;
(B) a volume resistance of the conductive adhesive ranges from 0.01 Ω·cm to 0.1 Ω·cm;
(C) a contact resistance of the conductive adhesive is ≤0.5 Ω·cm;
(D) a total resistance of the conductive adhesive is ≤1 mΩ;
(E) an electrolyte solution swelling ratio of the conductive adhesive is ≤0.10%; or
(F) an electrolyte solution dissolution rate of the conductive adhesive is ≤2%.

9. An electrochemical apparatus, comprising an electrode assembly and a shell, wherein the shell is provided with a terminal, the electrode assembly is provided with a tab; and the terminal and the tab are connected by using a conductive adhesive, the conductive adhesive comprises a substrate and a conductive filler, wherein the substrate comprises modified epoxy resin, polyurethane, and polyimide.

10. The electrochemical apparatus according to claim 9, wherein based on a mass of the conductive adhesive, a mass content of the substrate ranges from 50% to 85%, and a mass content of the conductive filler ranges from 10% to 45%.

11. The electrochemical apparatus according to claim 9, wherein based on a mass of the substrate, a mass content of the modified epoxy resin ranges from 70% to 90%, a mass content of the polyurethane ranges from 5% to 20%, and a mass content of the polyimide ranges from 5% to 20%.

12. The electrochemical apparatus according to claim 9, wherein the modified epoxy resin comprises carboxyl and/or cyano.

13. The electrochemical apparatus according to claim 9, wherein the conductive filler comprises at least one selected from the group consisting of Au, Ag, Ni, Cu, Zn, graphite, and graphene.

14. The electrochemical apparatus according to claim 9, wherein the conductive filler satisfies at least one of the following conditions (i) to (iii):
(i) a surface shape of the conductive filler comprises one or more of a sheet shape, a spherical shape, or a dendritic shape;
(ii) a particle size of the conductive filler ranges from 0.1 μm to 100 μm; or
(iii) a stacking density of the conductive filler ranges from 2 g/cm³ to 15 g/cm³.

15. The electrochemical apparatus according to claim 9, wherein the conductive adhesive has at least one of the following characteristics (a) to (e):
(a) a viscosity of the conductive adhesive ranges from 50 Pa·s to 300 Pa·s;
(b) a thixotropic index of the conductive adhesive ranges from 1 to 5;
(c) a curing temperature of the conductive adhesive is ≤150° C.;
(d) an adhesive line width change rate of the conductive adhesive is ≤75%; or
(e) a thermal weight loss rate of the conductive adhesive is ≤0.2%.

16. The electrochemical apparatus according to claim 9, wherein the conductive adhesive has at least one of the following characteristics (A) to (F):
(A) a tensile shear bonding strength of the conductive adhesive ranges from 5 MPa to 10 MPa;
(B) a volume resistance of the conductive adhesive ranges from 0.01 Ω·cm to 0.1 Ω·cm;
(C) a contact resistance of the conductive adhesive is ≤0.5 Ω·cm;
(D) a total resistance of the conductive adhesive is ≤1 mΩ;
(E) an electrolyte solution swelling ratio of the conductive adhesive is ≤0.1%; or
(F) an electrolyte solution dissolution rate of the conductive adhesive is ≤2%.

17. An electronic apparatus, comprising an electrochemical apparatus, the electrochemical apparatus, comprising an electrode assembly and a shell; wherein the shell is provided with a terminal, the electrode assembly is provided with a tab; and the terminal and the tab are connected by using a conductive adhesive, the conductive adhesive comprises a substrate and a conductive filler; wherein the substrate comprises modified epoxy resin, polyurethane, and polyimide.

18. The electronic apparatus according to claim 17, wherein based on a mass of the conductive adhesive, a mass content of the substrate ranges from 50% to 85%, and a mass content of the conductive filler ranges from 10% to 45%.

19. The electronic apparatus according to claim 17, wherein based on a mass of the substrate, a mass content of the modified epoxy resin ranges from 70% to 90%, a mass content of the polyurethane ranges from 5% to 20%, and a mass content of the polyimide ranges from 5% to 20%.

20. The electronic apparatus according to claim 17, wherein the modified epoxy resin comprises carboxyl and/or cyano.
